(19) United States
(12) Patent Application Publication
(10) Pub. No.: US 2010/0178526 A1
(43) Pub. Date: Jul. 15, 2010

(54) PROCESS FOR WORKING METAL MEMBERS AND STRUCTURES

(75) Inventors: Hidetoshi Fujii, Osaka (JP); Nobuhiro Tsuji, Osaka (JP)

Correspondence Address: OSHA LIANG L.L.P., TWO HOUSTON CENTER, 909 FANNIN, SUITE 3500, HOUSTON, TX, 77010, US

(73) Assignee: OSAKA UNIVERSITY, Suita-shi, Osaka (JP)

(21) Appl. No.: 12/438,353

(22) PCT Filed: Jul. 5, 2007
(86) PCT No.: PCT/JP2007/063481

§ 371 Date: Aug. 5, 2009

(30) Foreign Application Priority Data
Aug. 21, 2006 (JP) 2006-224752

(51) Int. Cl. B32B 15/01; B23K 20/12

(52) U.S. Cl. 428/615; 228/112.1

(57) ABSTRACT

Carbon steel materials having a carbon content of at least 0.15 mass % are caused to abut against each other in a welding part. The rear face side of the welding part is covered by a stainless-steel backing member, and then a tubular probe of a rotary tool is inserted into the front face side of the welding part to weld the metallic materials together. To perform the welding, the maximum attained temperature of the welding part is controlled so as not to exceed 723° C. or 737° C., or the cooling rate of the welding part is controlled to 75° C./s or lower. In this manner, the formation of a martensite phase in the metallic structure of the welding part can be prevented and hard-carbon steel can be welded together at a high intensity.

### TECHNICAL FIELD

The present invention relates generally to a method for welding a metallic material and a structure formed by the welding method, and particularly to a method for welding hard-carbon steel having a carbon content of at least 0.15 mass %.

### BACKGROUND ART

Hard-carbon steel used in railroad rails, tools, blades and the like is a material that cannot be welded easily due to its fragility. Generally, however, the more carbon content in carbon steel, the more strength the carbon steel provides, and hence the carbon steel is suitable as a structural material. Thus, if weldable, use of carbon steel with high carbon content is desired, but in many cases the carbon content in carbon steel is limited to a low level, depending on the weldability of the carbon steel.

Performing spot resistance welding on carbon steel with a carbon content of at least 0.15 mass % as in automobile assembly forms a hard and brittle martensite phase in a welded part. Therefore, in a case in which a cross tension strength test or other intensity test is conducted on such a welded sample, fracture within the nugget and significant decrease in strength or toughness of the sample had been discovered. For this reason, under the present circumstances a carbon steel material with a carbon content of 0.15 mass % or lower is used.

On the other hand, a technology for welding a metallic material by means of friction stir welding (FSW) has been known as a method for welding a metallic material. When performing the friction stir welding, metallic materials to be welded are placed to face a welding part. Then, a probe provided at a leading end of a rotary tool is inserted into the welding part, and the rotary tool is rotated and moved along a longitudinal direction of the welding part and the metallic materials are subjected to plastic flow by frictional heat to weld the two metallic materials to each other. Although friction stir welding for a ferrous material has not been put to practical use, the following Non-patent Documents 1 to 3 have reported that welding carbon steel by means of the friction stir welding in is performed in the research steps.

Non-patent Document 1: “Sci. Technol. Weld. Join. 4” by W. M. Thomas and two others, 1999, p. 365-372

Non-patent Document 2: “Weld. J. 82” by T. J. Lienert and three others, 2003, 1s-9s

Non-patent Document 3: “Sci, Technol. Weld. Join. 8” by A. P. Reynolds and three others, 2003, p. 455-460

### SUMMARY OF THE INVENTION

In the technology described above, however, a hard and brittle martensite phase might be formed in the welding part, causing breakage, as with the case where spot resistance welding or melt welding is performed.

One or more embodiments of the present invention provide a method for welding a metallic material that is capable of welding hard-carbon steel at a high intensity, and a structure formed by the welding method.

In one aspect, the present invention is directed to a method for welding a metallic material, in which the temperature of a welding part of a steel material having a carbon content of at least 0.15 mass % is controlled at 723° C. or lower, a rod-like rotary tool is inserted into the welding part, and the steel material is welded while rotating the rotary tool.

In another aspect, the present invention is a method for welding a metallic material, in which the temperature of a welding part of a steel material having a carbon content of at least 0.15 mass % is controlled at 737° C. or lower, a rod-like rotary tool is inserted into the welding part, and the steel material is welded while rotating the rotary tool.

According to this configuration, because friction stir welding is performed while controlling the temperature of the welding part at 723° C. or lower or 737° C. or lower, the formation of a hard and brittle martensite phase in the welding part can be prevented even when welding a hard-carbon steel material having a carbon content of at least 0.15 mass %. Therefore, hard-carbon steel can be welded at a higher intensity.

The method for welding a metallic material according to one or more embodiments of the present invention may have the following aspects (1) to (4) and a combination thereof: (1) friction stir welding in which the welding part (welding part) is formed by abutting edges of plate-like metallic materials against each other, and the rotary tool is rotated and moved along a longitudinal direction of the welding part to weld the metallic materials together; (2) spot friction stir welding (Spot FSW) in which the welding part (welding part) is formed by abutting edges of plate-like metallic materials against each other, and the rotary tool is rotated without being moved in the welding part, to weld the metallic materials together; (3) spot friction stir welding in which metallic materials are superimposed on each other in the welding part (welding part), the rotary tool is inserted into the welding part, and the rotary tool is rotated without being moved in this section, to weld the metallic materials together; and (4) friction stir welding in which metallic materials are superimposed on each other in the welding part (welding part), the rotary tool is inserted into the welding part, and the rotary tool is rotated and moved along a longitudinal direction of the welding part to weld the metallic materials together. Alternatively, the method for welding a metallic material according to one or more embodiments of the present invention has an aspect of inserting the rotary tool into a steel welding part and rotating the rotary tool to modify a steel surface section of the welding part. In this manner, the strength and elongation of hard-carbon steel can be improved.

In this case, controlling the temperature of the welding part is preferably performed by controlling the rotation speed and movement speed of the rotary tool.

According to this configuration, because the temperature of the welding part is controlled by controlling the rotation speed and movement speed of the rotary tool, the temperature of the welding part can be controlled simply by controlling the rotation speed and movement speed of the rotary tool to predetermined values without actually measuring the temperature of the welding part. The movement speed may indicate the movement speed of the rotary tool in a case of friction stir welding where the rotary tool is moved to weld the metallic materials together, but may indicate the inverse of the retention time during which the rotary tool remains in the welding part in a case of performing spot friction stir welding for welding the metallic materials together without moving the rotary tool or in a case of modifying the steel surface.

In this case, the rotary tool is configured by a main body of the rod-like rotary tool and a probe that is disposed to pass through the inside of the main body of the rod-like rotary tool and inserted into the welding part, and controlling the temperature of the welding part is preferably performed by making the rotation speed of the main body of the rotary tool lower than the rotation speed of the probe.

According to this configuration, because the rotation speed of the main body of the rotary tool is lower than the rotation speed of the probe, a shoulder part can be prevented from coming into contact with the welding part faster than the probe, and the temperature of the welding part can be set at 723° C. or 737° C. or lower.

In another aspect, the present invention is directed to a method for welding a metallic material, in which a rod-like rotary tool is inserted into a welding part of steel materials having a carbon content of at least 0.15 mass %, the rotary tool is rotated to weld the steel materials, and the cooling rate of the welding part obtained after the welding is controlled to 75° C./s or lower.

According to this configuration, because the cooling rate of the welding part obtained after the welding is controlled to 75° C./s or lower, the formation of a hard and brittle martensite phase in the welding part can be prevented, and hard-carbon steel can be welded at a higher intensity. Alternatively, the strength and elongation of the hard-carbon steel can be improved in a case of modifying a surface of the steel welding part.

In this case, controlling the cooling rate of the welding part is preferably performed by controlling the rotation speed and movement speed of the rotary tool.

According to this configuration, because the cooling rate of the welding part is controlled by controlling the rotation speed and movement speed of the rotary tool, the cooling rate of the welding part can be controlled simply by controlling the rotation speed and movement speed of the rotary tool to predetermined values without actually measuring the cooling rate of the welding part.

In this case, the rotary tool is configured by a main body of the rod-like rotary tool and a probe that is disposed to pass through the inside of the main body of the rod-like rotary tool and inserted into the welding part, and controlling the cooling rate of the welding part is preferably performed by making the rotation speed of the main body of the rotary tool lower than the rotation speed of the probe.

According to this configuration, because the rotation speed of the main body of the rotary tool is lower than the rotation speed of the probe, a shoulder part can be prevented from coming into contact with the welding part faster than the probe, and the cooling rate of the welding part can be controlled to 75° C./s or lower.

In addition, the welding method according to one or more embodiments of the present invention can abut two steel materials against each other in the welding part and move the rotary tool along the longitudinal direction of the welding part while rotating the rotary tool, to weld the two steel materials together.

According to this configuration, linear welding can be performed by friction stir welding.

Alternatively, the welding method according to one or more embodiments of the present invention can superimpose the two steel materials on each other in the welding part, insert the rotary tool into the welding part, and rotate the rotary tool to weld the two steel materials together.

According to this configuration, spot friction stir welding can be performed.

Alternatively, the welding method according to one or more embodiments of the present invention can insert the rotary tool into the welding part and rotate the rotary tool to modify surface sections of the steel materials of the welding part.

According to this configuration, the tension and elongation of hard-carbon steel can be improved.

Moreover, in the welding method according to one or more embodiments of the present invention, the rotary tool is preferably configured by a WC.

According to this configuration, by providing the rotary tool with a WC of high thermal conductivity, the temperature or cooling rate of the welding part can be controlled.

In addition, in the welding method according to one or more embodiments of the present invention, it is preferred that the two steel materials be welded while supplying inactive gas to the welding part and the rotary tool.

According to this configuration, oxidation of the welding part and rotary tool can be prevented.

Moreover, another aspect of the present invention is a structure that is formed by welding two or more steel materials by means of the method for welding a metallic material according to one or more embodiments of the present invention.

According to this configuration, metallic materials having a carbon content of at least 0.15 mass % are welded together at a high intensity to obtain a structure of higher strength.

The method for welding a metallic material according to one or more embodiments of the present invention can weld hard-carbon steel at a higher intensity. Moreover, the structure formed by the method for welding a metallic material according to one or more embodiments of the present invention can be of higher strength.

### BRIEF DESCRIPTION OF THE DRAWINGS

FIG. 1 is a perspective view showing a first embodiment of a method for welding a metallic material according to the present invention;

FIG. 2 is a phase diagram of carbon steel, in which a carbon content and temperature are used as parameters;

FIG. 3 is a graph showing a relationship between the welding speed obtained when the rotation speed of a rotary tool is constant and the maximum attained temperature of a welding part;

FIG. 4 is a graph showing a relationship between the welding speed obtained when the rotation speed of the rotary tool is constant and the cooling rate of the welding part;

FIG. 5 is a graph showing a relationship between the rotation speed of the rotary tool obtained when the welding speed is constant and the maximum attained temperature of the welding part;

FIG. 6 is a graph showing a relationship between the rotation speed of the rotary tool obtained when the welding speed is constant and the cooling rate of the welding part;

FIG. 7 is a perspective view showing a second embodiment of a method for welding a metallic material according to the present invention;

FIG. 8 is a perspective view showing a third embodiment of a method for welding a metallic material according to the present invention;

FIG. 9 is a diagram showing the compositions of samples used in an experimental example;

FIG. 10 is a drawing showing a metallic structure of the welding part in the experimental example;

FIG. 11 is a drawing showing a metallic structure of the welding part in the experimental example;

FIG. 12 is a drawing showing a metallic structure of the welding part in the experimental example;

FIG. 13 is a drawing showing a metallic structure of the welding part in the experimental example;

FIG. 14 is a drawing showing a metallic structure of the welding part in the experimental example;

FIG. 15 is a drawing showing a metallic structure of the welding part in the experimental example;

FIG. 16 is a drawing showing a metallic structure of the welding part in the experimental example;

FIG. 17 is a drawing showing a metallic structure of the welding part in the experimental example;

FIG. 18 is a drawing showing a metallic structure of the welding part in the experimental example;

FIG. 19 is a drawing showing a metallic structure of the welding part in the experimental example;

FIG. 20 is a drawing showing a metallic structure of the welding part in the experimental example;

FIG. 21 is a drawing showing a metallic structure of the welding part in the experimental example;

FIG. 22 is a drawing showing a metallic structure of the welding part in the experimental example;

FIG. 23 is a drawing showing a metallic structure of the welding part in the experimental example; and

FIG. 24 is a drawing showing a metallic structure of the welding part in the experimental example.

### EXPLANATION OF REFERENCE NUMERALS

1, 2 Carbon steel

3 Welding part

4 Backing member

5 Rotary tool

6 Probe

8 Shield cover

### DETAILED DESCRIPTION

Embodiments of the present invention are now described below with reference to the drawings.

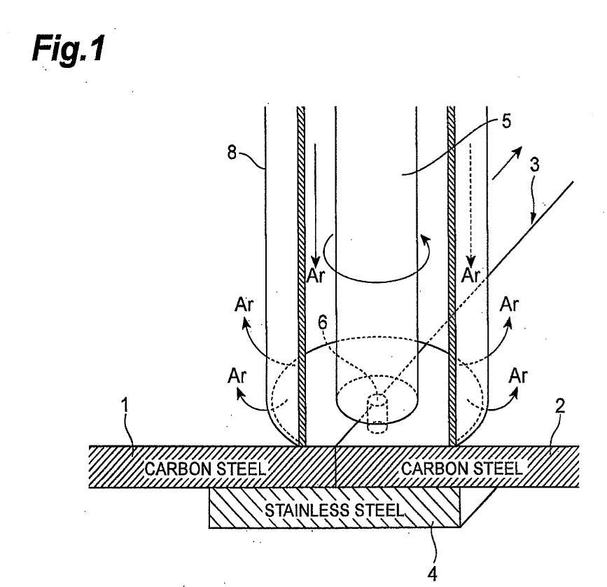

FIG. 1 is a perspective view showing a first embodiment of a method for welding a metallic material according to the present invention. In this embodiment, as shown in FIG. 1, edges of plate-like carbon steel materials 1, 2 are caused to abut against each other in a welding part 3, the rear face side of the welding part 3 is covered by a plate-like backing member 4, and then a probe 6 of a rotary tool 5 is inserted into the front face side of the welding part 3 to weld the carbon steel materials 1, 2 together. A shield cover 8 is disposed on the front face side of the welding part 3 to surround the rotary tool 5.

In the present embodiment, the carbon steel materials 1, 2 to be welded to each other are hard-carbon steel having a carbon content of at least 0.15 mass %. The welding method of the present embodiment is applicable to the case in which carbon steel is welded to, not the same types of materials, but various dissimilar metals such as an Al alloy material, Mg alloy, Cu alloy, Ni alloy, and Ti alloy, or to the case in which carbon steel is welded to stainless steel or other ferrous materials other than carbon steel.

As shown in FIG. 1, the rotary tool 5 is substantially in the form of a cylinder and, at a leading end thereof, has a substantially tubular probe 6 having a diameter smaller than that of a main body of the rotary tool 5. The material of the rotary tool 5 is preferably a cemented carbide such as WC, ceramics such as Si₃N₄ and PCBN, and refractory metals such as W, Mo and Ir alloy. The distance between the backing member 4 and a leading end of the probe 6 of the rotary tool 5 inserted into the welding part 3 is preferably set as short as possible so as not to create an non-welding part.

Stainless steel with high strength can be used as the backing member 4. Also, ceramics or the like having low thermal conductivity and high heat resistance and strength can be used as the backing member 4 in order to make temperature gradients smaller within the carbon steel materials 1, 2.

The shield cover 8 has a substantially cylindrical shape and is disposed to surround the rotary tool 5. The shield cover 8 is so designed that the rotary tool 5 can be moved along a longitudinal direction the welding part 3 upon welding the carbon steel materials 1, 2 together and that the shield cover 8 can move in the same direction while surrounding the rotary tool 5. When welding the carbon steel materials 1, 2 together, inactive gas is supplied into the shield cover 8 as shielding gas. Examples of the inactive vas used as the shielding gas include Ar gas.

As shown in FIG. 1, in the present embodiment the carbon steel materials 1, 2 can be welded to each other by inserting the probe 6 of the rotary tool 5 into the welding part 3, supplying the shielding gas into the shield cover 8, and at the same time moving the rotary tool 5 along the longitudinal direction of the welding part 3 while rotating the rotary tool 5.

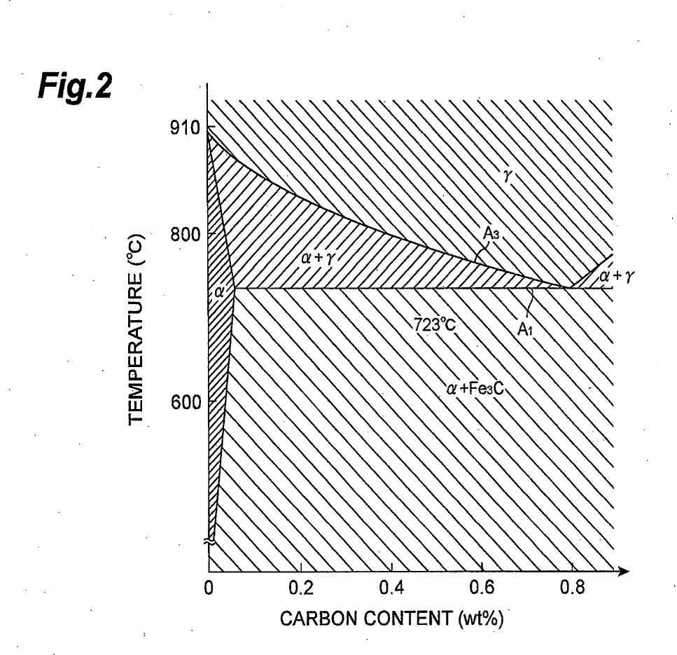

In the present embodiment, the temperature of the welding part 3 is controlled to 723° C. or lower, the cooling rate of the welding part 3 is controlled to 75° C./s or lower after welding the carbon steel materials 1, 2 together. FIG. 2 is a phase diagram of carbon steel, in which a carbon content and temperature are used as parameters. As shown in FIG. 2, in a case of hard-carbon steel having a carbon content of at least 0.15 mass %, the metallic structure of the carbon steel is configured by ferrite (α) and cementite (Fe₃C) that form a body-centered cubic lattice (the area shown by α+Fe₃C in FIG. 2) until the temperature of the welding part 3 exceeds a temperature point A₁ of 723° C. When the temperature point A₁ of 723° C. is exceeded, the metallic structure of the carbon steel is changed to a phase where the metallic structure is configured by ferrite (α) and austenite (γ) forming a face-centered cubic lattice (the area shown by α+γ in FIG. 2) until a temperature point A₃ is exceeded. When the temperature point A₃ is exceeded, the metallic structure of the carbon steel is changed to a phase where the metallic structure is configured by austenite (γ) only (the area shown by γ in FIG. 2).

On the other hand, when the metallic structure of the carbon steel is cooled from the area equal to or above the temperature point A₁ of 723° C., and when the cooling rate is high, the metallic structure of the carbon steel is changed to a hard and brittle martensite phase. Even when the cooling rate is lowered, the metallic structure of the carbon steel is still changed to hard and brittle bainite phase. Specifically, in a case of welding the carbon steel by means of friction stir welding, when the temperature of the welding part is set at temperature above the temperature point A₁ of 723° C. and thereafter the welding part is cooled suddenly, the metallic structure of the carbon steel is changed to the hard and brittle martensite phase or bainite phase, which is the cause of degradation of the strength of the welding part. However, even when the metallic structure of the carbon steel is cooled from the area equal to or above the temperature point A₁ of 723° C., and when the cooling rate is set at 75° C./s or lower, preferably 50° C./s or lower, or more preferably 20° C./s or lower to cool the metallic structure gradually, the metallic structure of the carbon steel returns to the phase where the metallic structure is configured from cementite and ferrite, and hence the metallic structure is not embrittled.

In view of the above facts, the following two methods are considered in order not to form the martensite phase or bainite phase.

(1) Setting the maximum attained temperature at equal to or lower than the temperature point A₁ of 723° C. upon welding.

(2) Setting the cooling rate at 75° C./s or lower, preferably 50° C./s or lower, or more preferably 20° C./s or lower.

In this case, the maximum attained temperature and the cooling rate may be controlled based on the values measured while welding the carbon steel, but the maximum attained temperature and the cooling rate can be controlled by controlling the rotation speed of the rotary tool and the welding speed (movement speed). In other words, the maximum attained temperature is increased by increasing the rotation speed of the rotary tool and reducing the welding speed. On the other hand, the cooling rate increases when the rotation speed of the rotary tool is increased, but the cooling rate is reduced when the welding speed is lowered. Therefore, it is assumed that controlling these two parameters can control both the maximum attained temperature and the cooling rate.

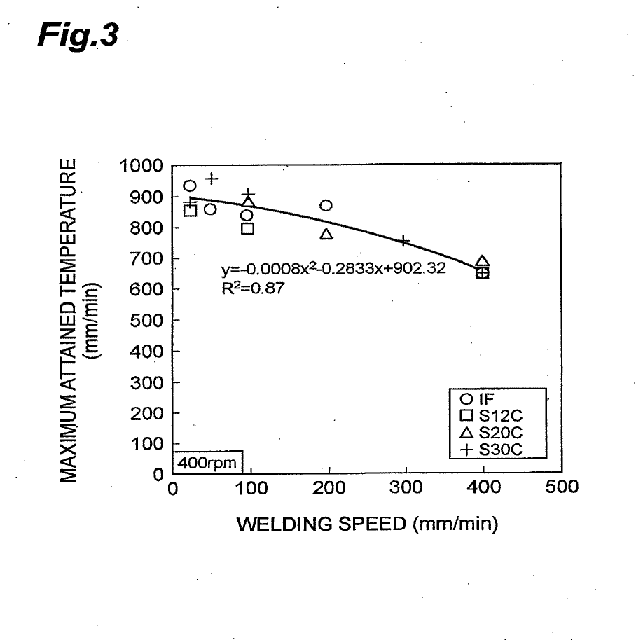

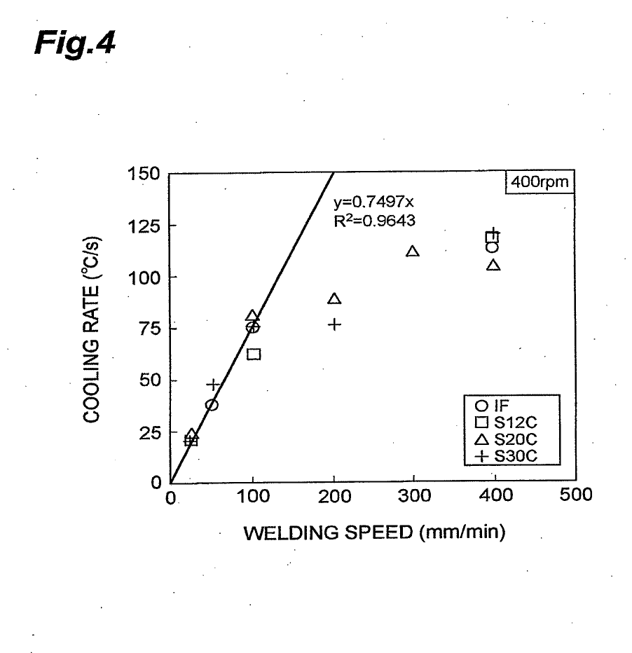

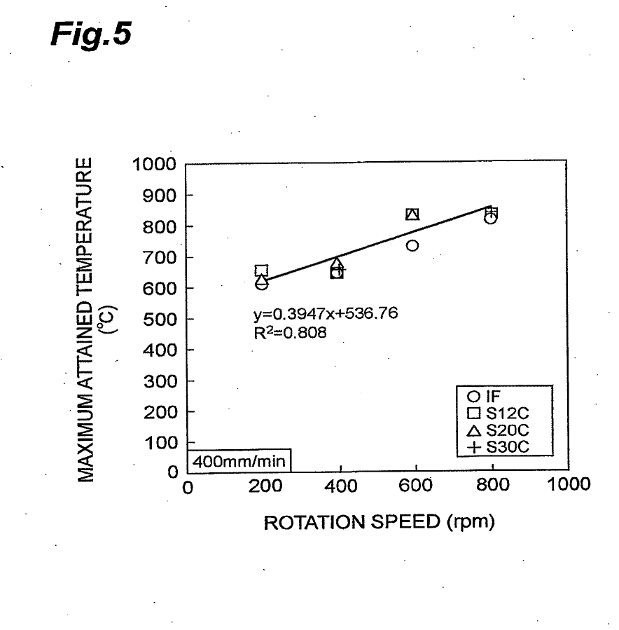

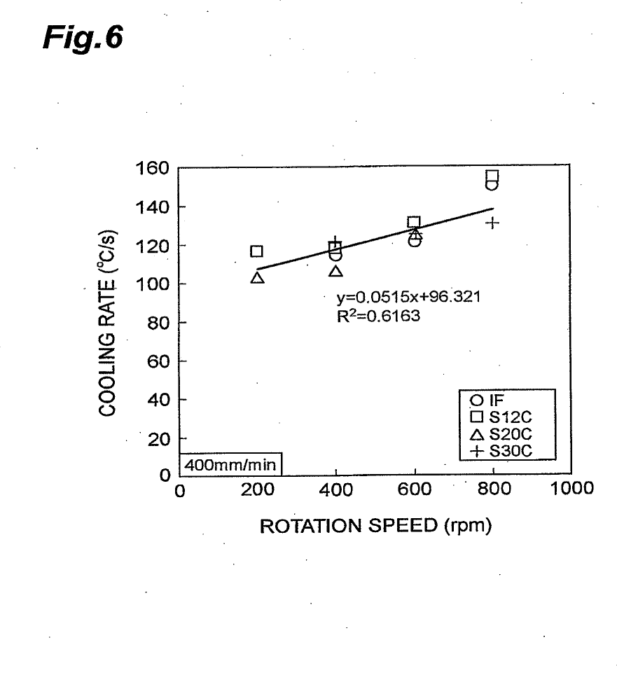

FIG. 3 is a graph showing a relationship between the welding speed obtained when the rotation speed of the rotary tool is constant and the maximum attained temperature of the welding part. FIG. 4 is a graph showing a relationship between the welding speed obtained when the rotation speed of the rotary tool is constant and the cooling rate of the welding part. FIG. 5 is a graph showing a relationship between the rotation speed of the rotary tool obtained when the welding speed is constant and the maximum attained temperature of the welding part. FIG. 6 is a graph showing a relationship between the rotation speed of the rotary tool obtained when the welding speed is constant and the cooling rate of the welding part. Hereinafter, control of the maximum attained temperature and the cooling rate is examined based on FIGS. 3 to 6.

(Maximum Attained Temperature)

It is sufficient that the maximum attained temperature T (° C.) be 723° C. or lower in order not to form martensite phase. The following approximate expressions for the rotation speed RS (rpm) and welding speed WS (mm/min) of the rotary tool are developed based on the results shown in FIGS. 3 and 5.

T=−0.0008×WS²−0.28WS+900 Expression (1)

T=0.39RS+540 Expression (2)

Maximum attained temperature T=694° C. is expressed by expression (2), with rotation speed RS=400 mm/min, and expression (1) is multiplied by (0.39RS+540)/694. The result is shown in the following expression (3).

T=−(4.5×10⁻⁷RS+6.2×10⁻⁴)WS²−(1.6×10⁻⁴RS+0.22)WS+(0.51RS+700) Expression (3)

A maximum attained temperature T of 723° C. or lower does not form the martensite phase, but satisfying the following expression (4) in consideration of an error of approximately 100° C. prevents the formation of the martensite phase.

T=−(4.5×10⁻⁷RS+6.2×10⁻⁴)WS²−(1.6×10⁻⁴RS+0.22)WS+(0.51RS+700)<823 Expression (4)

The coefficient 0.39 in expression (2) is thought to be associated with the friction coefficient and the shoulder diameter of the rotary tool and the sample. Therefore, in a case of a tool having a friction coefficient f times greater than that of the cemented carbide (WC+6% Co) which is the material of the rotary tool used in the measurements shown in FIGS. 3 to 6, the maximum attained temperature can be approximated by the following expression (5). Also, in a case of a tool having a shoulder diameter m times greater than that of the rotary tool with a shoulder diameter of 15 mm that is used in the measurements shown in FIGS. 3 to 6, the maximum attained temperature can be approximated by the following expression (5).

T=−(4.5×10⁻⁷RS×f×m^{1.5}+6.2×10⁻⁴)WS²−(1.6×10⁻⁴RS×f×m^{1.5}+0.22)WS+(0.51RS×f×m^{1.5}+700)<823 Expression (5)

As will be shown in the following experimental examples, when the inventors of the present invention actually welded an S12C steel plate, S20C steel plate and S30C steel plate together by means of friction stir welding, they have confirmed that the formation of the martensite phase was prevented with welding speed WS=400 mm/min and rotation speed less than RS=600 rpm. When rotation speed RS=600 rpm, the temperature of the welding part is T=737.2° C. according to the above expression (2), so welding to achieve T=737° C. or lower can prevent the formation of the martensite phase.

Therefore, the expressions (4) and (5) can be changed as follows in consideration of an error of approximately 100° C.

T=−(4.5×10⁻⁷RS+6.2×10⁻⁴)WS²−(1.6×10⁻⁴RS+0.22)WS+(0.51RS+700)<837 Expression (4)′

T=−(4.5×10⁻⁷RS×f×m^{1.5}+6.2×10⁻⁴)WS²−(1.6×10⁻⁴RS×f×m^{1.5}+0.22)WS+(0.51RS×f×m^{1.5}+700)<837 Expression (5)′

It is considered that the maximum attained temperature can be approximated when the rise of the temperature of the welding part from the ambient temperature is inversely proportional to the thickness of the plates and when the cooling rate is proportional to the thickness of the plates. Therefore, in a case a carbon steel plate that is thicker than the carbon steel plate with a plate thickness of 1.6 mm that is used in the measurements shown in FIGS. 3 to 6, in order to prevent the formation of the martensite phase on the rear face side of this carbon steel plate (the side opposite to the side into which the rotary tool is inserted), each parameter is controlled so that the condition of T′=T/n is satisfied in the left-hand side of the above expressions (1) to (5) or (4)′ and (5)′ for the carbon steel plate having a plate thickness n times greater than the 1.6 mm plate thickness. In this manner, the formation of martensite on the rear face side of the carbon steel plate can be prevented. Even in a case of the front face side of the carbon steel plate that is thicker than the carbon steel plate having 1.6 mm plate thickness (the same side as the one into which the rotary tool is inserted), the above expressions (1) to (5) or (4)′ and (5)′ can be directly applied.

Moreover, when a ceramic backing member having a lower thermal conductivity than the stainless-steel backing member used in the measurements shown in FIGS. 3 to 6 is used, the rise of the temperature of the welding part from the ambient temperature increases, whereas the cooling rate decreases. Therefore, in order to prevent the formation of the martensite phase on the rear face side of the carbon steel plate, the maximum attained temperature is controlled by increasing the left-hand side of the above expressions (1) to (5) or (4)′ and (5)′ in accordance with the thermal conductivity of the backing member. In this manner, the formation of the martensite phase on the rear face side of the carbon steel plate can be prevented. Even when the backing member with low thermal conductivity is used, the above expressions (1) to (5) or (4)′ and (5)′ can be directly applied to the front face side of the carbon steel plate.

(Cooling Rate)

Because the cooling rate CR (° C./s) has a lower dependency on the rotation speed RS (rpm) of the rotary tool than on the welding speed WS (mm/min), a correction value is obtained by multiplying the dependency on the welding speed by the dependency on the rotation speed. The cooling rate has to be lower than critical cooling rate CCR (° C./s) in order to prevent the formation of the martensite phase, and hence the following relational expression is created based on the result that the rotation speed and the welding speed are 100 mm/min or lower as expressed by a linear relation as shown in FIGS. 4 and 6.

CR=0.75×WS Expression (1)

CR=0.052RS+96 Expression (2)

Because the cooling rate CR=117° C./s is expressed by expression (2), with rotation speed RS=400 mm/min, and expression (1) is multiplied by (0.052RS+96)/117. The result is shown in the following expression (3).

CR=0.00033WS×RS+0.62WS Expression (3)

When the cooling rate is equal to or lower than lower critical cooling rate, the martensite phase is not formed. According to the experimental results shown in FIGS. 3 to 6, the lower critical cooling rate of S20C and S30 C is 75° C./s when the welding speed is 100 mm/min. Also, according to the nonpatent literatures, the critical cooling rate of S50C is approximately 50° C./s, and the critical cooling rate of S70C is approximately 20° C./s. Specifically, satisfying the following expression (4) in consideration of an error of approximately 20° C. prevents the formation of the martensite phase.

CR=0.00033WS×RS+0.62WS<CCR−20 Expression (4)

The coefficient 0.39 in expression (2) is thought to be associated with the friction coefficient and the shoulder diameter of the rotary tool and the sample. Therefore, in a case of a tool having a friction coefficient f times greater than that of the cemented carbide (WC+6% Co) which is the material of the rotary tool used in the measurements shown in FIGS. 3 to 6, the cooling rate can be approximated by the following expression (5). Also, in a case of a tool having a shoulder diameter m times greater than that of the rotary tool with a shoulder diameter of 15 mm that is used in the measurements shown in FIGS. 3 to 6, cooling rate can be approximated by the following expression (5).

CR=0.00033WS×RS×f×m^{1.5}+0.62WS<CCR−20 Expression (5)

It is considered that the cooling rate can be approximated when the rise of the temperature of the welding part from the ambient temperature is inversely proportional to the thickness of the plates and when the cooling rate is proportional to the thickness of the plates. Therefore, in a case a carbon steel plate that is thicker than the carbon steel plate with a plate thickness of 1.6 mm that is used in the measurements shown in FIGS. 3 to 6, in order to prevent the formation of the martensite phase on the rear face side of this carbon steel plate (the side opposite to the side into which the rotary tool is inserted), each parameter is controlled so that the condition of CR′=CR×n is satisfied in the left-hand side of the above expressions (1) to (5) for the carbon steel plate having a plate thickness n times greater than the 1.6 mm plate thickness. In this manner, the formation of martensite on the rear face side of the carbon steel plate can be prevented. Even in a case of the front face side of the carbon steel plate that is thicker than the carbon steel plate having 1.6 mm plate thickness (the same side as the one into which the rotary tool is inserted), the above expressions (1) to (5) can be directly applied.

Moreover, when a ceramic backing member having a lower thermal conductivity than the stainless-steel backing member used in the measurements shown in FIGS. 3 to 6 is used, the rise of the temperature of the welding part from the ambient temperature increases, whereas the cooling rate decreases. Therefore, in order to prevent the formation of the martensite phase on the rear face side of the carbon steel plate, the maximum attained temperature is controlled by reducing the left-hand side of the above expressions (1) to (5) in accordance with the thermal conductivity of the backing member. In this manner, the formation of the martensite phase on the rear face side of the carbon steel plate can be prevented. Even when the backing member with low thermal conductivity is used, the above expressions (1) to (5) can be directly applied to the front face side of the carbon steel plate.

By controlling the rotation speed and the welding speed of the rotary tool so as to satisfy the above conditions, the maximum attained temperature and the cooling rate can be controlled so that the martensite phase is not formed.

In the present embodiment, because friction stir welding is performed while controlling the maximum attained temperature of the welding part 3 to 723° C. or lower or 737° C. or lower, the formation of hard and brittle martensite on the welding part 3 can be prevented and hard-carbon steel can be welded together at a high intensity, even when welding together the carbon steel materials 1, 2 having a carbon content of at least 0.15 mass %.

Moreover, in the present embodiment, because the cooling rate of the welding part 3 is controlled to 75° C./s or lower after welding the carbon steel materials 1, 2 together, the formation of hard and brittle martensite on the welding part 3 can be prevented and hard-carbon steel can be welded together at a high intensity.

In addition, in the present embodiment, because the maximum attained temperature and the cooling rate of the welding part 3 is controlled by controlling the rotation speed and the welding speed of the rotary tool 5, the maximum attained temperature and the cooling rate of the welding part can be controlled simply by controlling the rotation speed and movement speed of the rotary tool to predetermined values without actually measuring the maximum attained temperature and the cooling rate of the welding part 3.

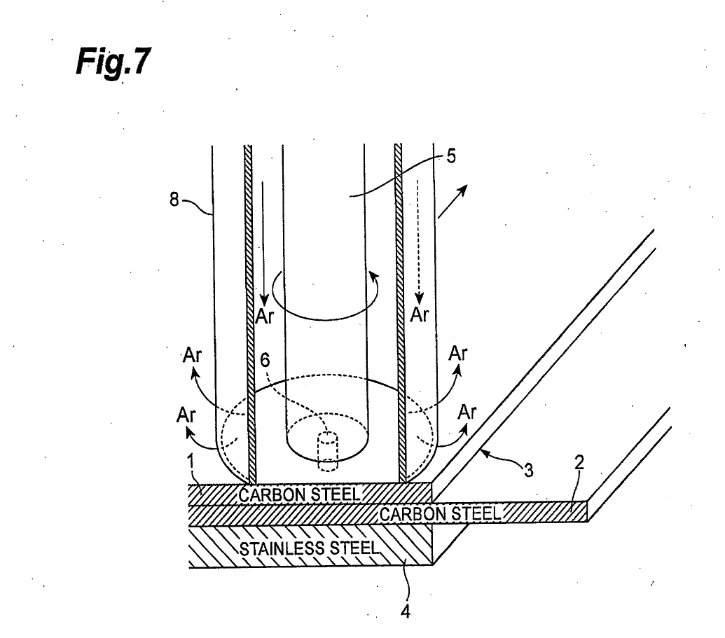

FIG. 7 is a perspective view showing a second embodiment of a method for welding a metallic material according to the present invention. As shown in FIG. 7, in the present embodiment the carbon steel materials 1, 2 are superimposed on each other in the welding part 3, the rotary tool 5 is inserted into the welding part 3 via one of the carbon steel materials, the carbon steel material 1, and the carbon steel materials 1, 2 are welded together while rotating the rotary tool 5. In a similar manner, friction stir welding can be performed in a wider welding part 3 as well, by successively inserting and rotating a rotary tool 18 in another section. In the present embodiment, the inverse of the retention time during which the rotary tool 5 remains in the welding part 3 is made correspond to the welding speed obtained in the first embodiment, to control the maximum attained temperature and the cooling rate of the welding part 3. In addition, the cooling rate in the present embodiment can be controlled by the rotation speed of the rotary tool 5, retention time, and the pulling speed of the rotary tool 5.

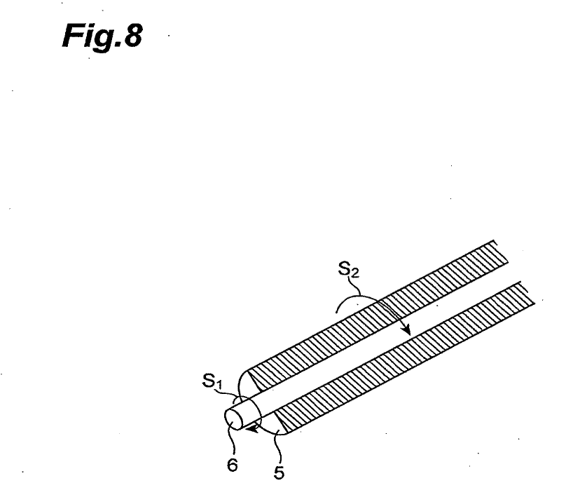

When controlling the maximum attained temperature of the welding part 3, the main body of the rotary tool 5 (shoulder part) comes into contact with the welding part 3 faster than the probe 6 having a diameter smaller than that of the main body, hence there is a possibility that the maximum attained temperature exceeds 723° C. or 737° C. at the shoulder part only. Also, when controlling the cooling rate of the welding part 3, the shoulder part of the rotary tool 5 comes into contact with the welding part 3 faster than the probe 6 having a diameter smaller than that of the main body, hence the cooling rate varies between the probe 6 and the shoulder part, making it difficult to control the cooling rate to 75° C./s or lower. FIG. 8 is a perspective view showing a third embodiment of a method for welding a metallic material according to the present invention. As shown in FIG. 8, in this embodiment the probe 6 is inserted into the main body of the rotary tool 5. The rotation speed S₂ of the rotary tool 5 is set to be lower than the rotation speed S₁ of the probe 6. In this manner, the shoulder part can be prevented from coming into contact with the welding part 3 faster than the probe 6, and the temperature of the welding part 3 can be set at 723° C. or lower or 737° C. or lower. It also becomes easy to control the cooling rate of the welding part 3 at 75° C./s or lower.

The method for welding a metallic material according to the present invention is not limited to the one described in the above embodiments and can be changed in various ways within the scope not deviating from the gist of the present invention. For example, the above embodiments have described the example of controlling the maximum attained temperature and the cooling rate of the welding part by controlling the rotation speed and the welding speed of the rotary tool to predetermined values, but the maximum attained temperature and the cooling rate of the welding part can be controlled using another method. For example, because the cooling rate of the welding part and the rise of the temperature of the welding part from the ambient temperature are considered proportional to the pressure applied to the welding part by the rotary tool, the maximum attained temperature and the cooling rate of the welding part can be controlled by controlling the pressure applied to the welding part by the rotary tool. Alternatively, the maximum attained temperature and the cooling rate of the welding part can be controlled using an external heat source, thermal insulation member, cooling means, and cooling medium that are provided as separate parts. In this case, as the external heat source, the one using a laser, micro arc, plasma arc, and electromagnetic induction heating method can be employed. Moreover, as the cooling means and cooling medium, the one using liquid CO₂ or water-cooling method can be employed.

In addition, although the above embodiments have described only the carbon content of the carbon steel material, one or more embodiments of the present invention can be applied to a carbon steel material having different element content. For example, for a carbon steel material that has the mass % of carbon (C), phosphorus (P), sulfur (S), silicon (Si), manganese (Mn), or chromium (Cr) corresponding to the following expressions (1) to (4), the welding method of the present invention can be used for controlling the maximum attained temperature and the cooling rate of the welding part so that a welding part better than the conventional one can be obtained.

1.5C+P+3S≧0.23 (mass %) Expression (1)

C+Si/90+(Mn+Cr)/100+P≧0.115 (mass %) Expression (2)

C+Si/30+Mn/60+2P+4S≧0.024 (mass %) (retention 25 cycles) Expression (3)

C+Si/30+Mn/60+2P+4S≧0.031 (mass %) (retention 5 cycles) Expression (4)

Next are described the experimental results that are obtained by the inventors of the present invention by actually welding the metallic materials together using the method for welding a metallic material according to one embodiment of the present invention.

### Experimental Example 1

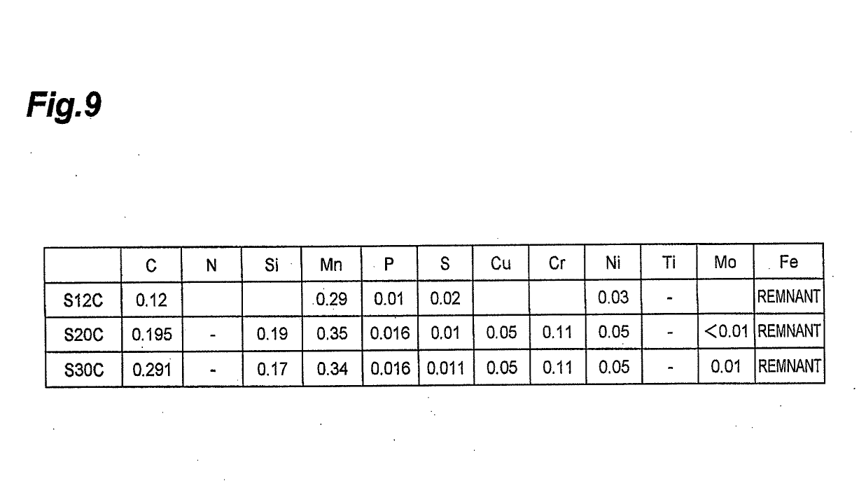

An S12C steel plate, S20C steel plate and S30C steel plate having a thickness of 1.6 mm were prepared. The prepared S12C steel plate, S20C steel plate and S30C steel plate were welded together using the method shown in FIG. 1, to create a test piece. A stainless-steel plate material was used as the backing member 4 and a cemented-carbide (WC+6% Co) rotary tool with a diameter of 15 mm as the rotary tool 5, to perform friction stir welding while changing the rotation speed and welding speed of the rotary tool, and the metallic structure of the welding part 3 as observed. The compositions of the samples are shown in FIG. 9.

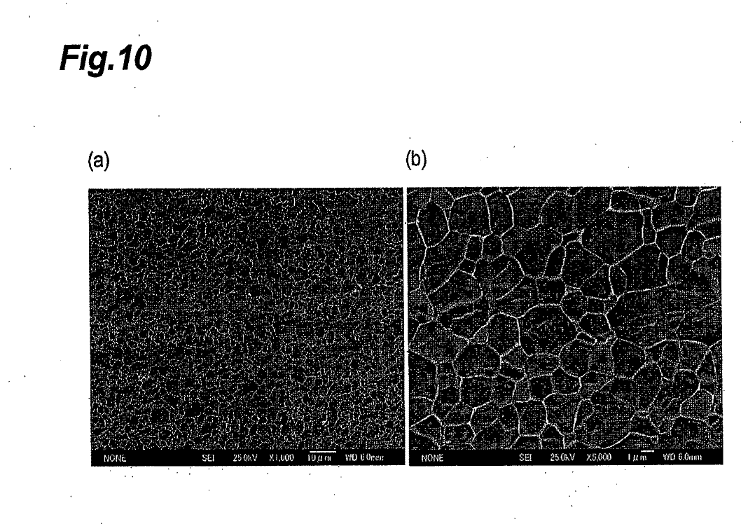

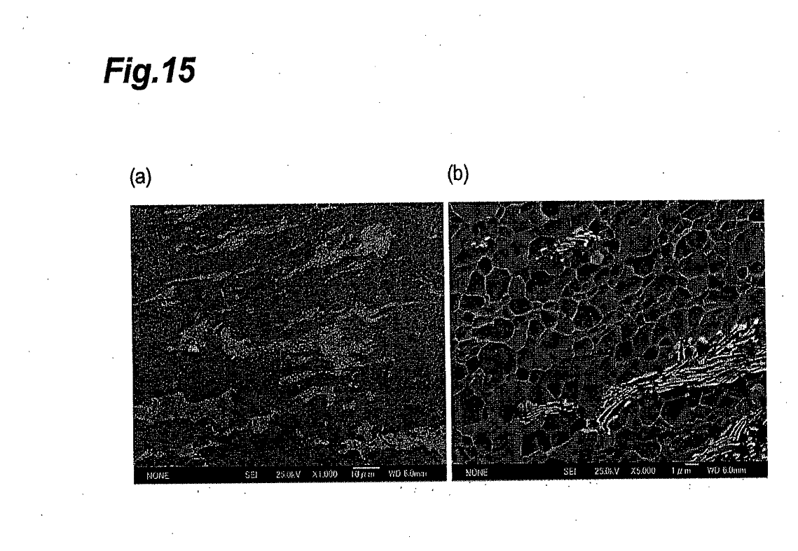

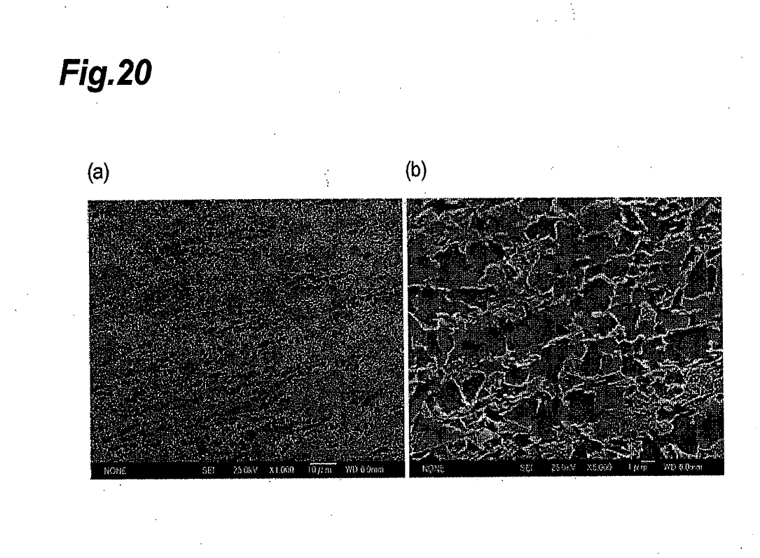

FIGS. 10 to 14 are diagrams each showing the metallic structure of the welding part of the S12C. FIGS. 15 to 19 are diagrams each showing the metallic structure of the welding part of the S20C. FIGS. 20 to 24 are diagrams each showing the metallic structure of the welding part of the S30C.

Each of (a) and (b) of FIG. 10 shows the metallic structure obtained by welding the S12C at a rotation speed of the rotary tool 5 of 200 rpm and a welding speed of the same of 400 mm/min. (b) of FIG. 10 is a magnification of (a) of FIG. 10. In this case, the martensite phase is not formed, as the maximum attained temperature of the welding part 3 is equal to or lower than 723° C. and 737° C.

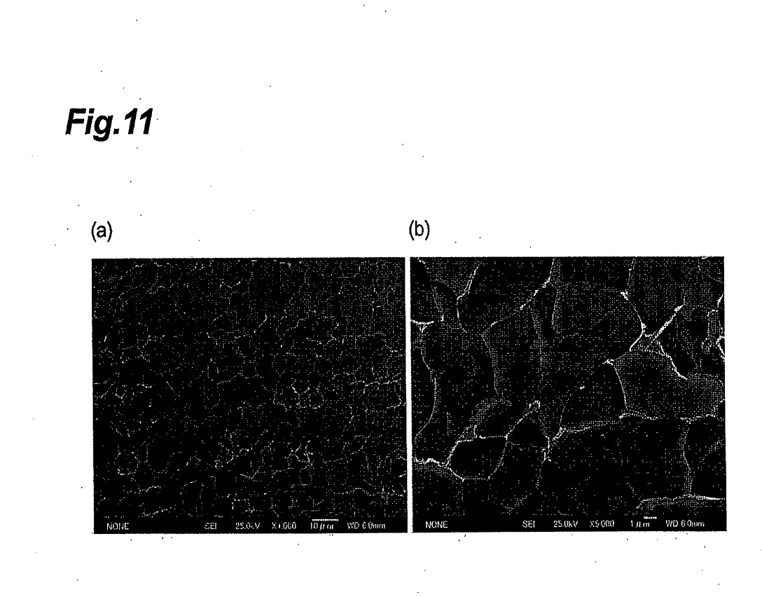

Each of (a) and (b) of FIG. 11 shows the metallic structure obtained by welding the S12C at a rotation speed of the rotary tool 5 of 400 rpm and a welding speed of the same of 400 mm/min. (b) of FIG. 11 is a magnification of (a) of FIG. 11. In this case, the crystal grain size of the metallic structure of the welding part 3 increases but the martensite phase is not formed, as the maximum attained temperature of the welding part 3 is equal to or lower than 723° C. and 737° C.

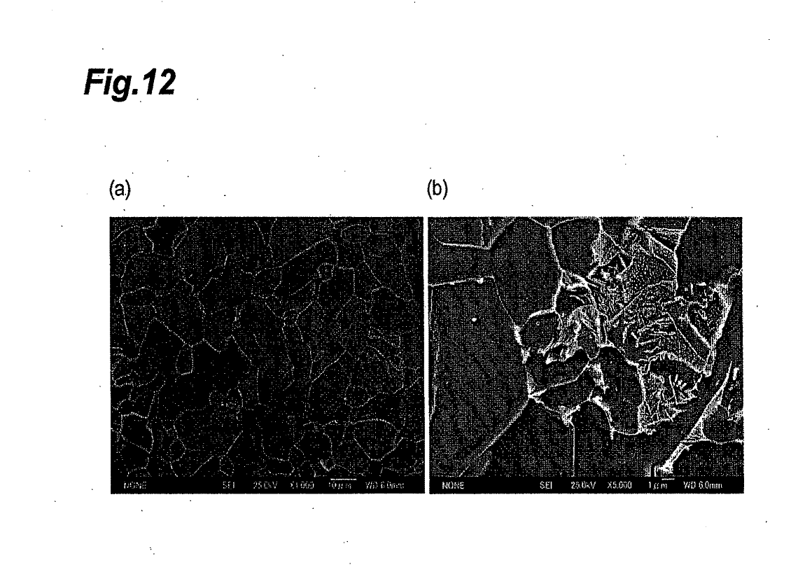

Each of (a) and (b) of FIG. 12 shows the metallic structure obtained by welding the S12C at a rotation speed of the rotary tool 5 of 600 rpm and a welding speed of the same of 400 mm/min. In this case, the maximum attained temperature of the welding part 3 exceeds 723° C. and reaches 737° C., and the cooling rate of the same also exceeds 75° C./s. Therefore, it is found that the bainite phase is formed only partially, as shown in a magnification of the relevant section in (b) of FIG. 12. However, such partial formation has no adverse impact on the mechanical characteristics.

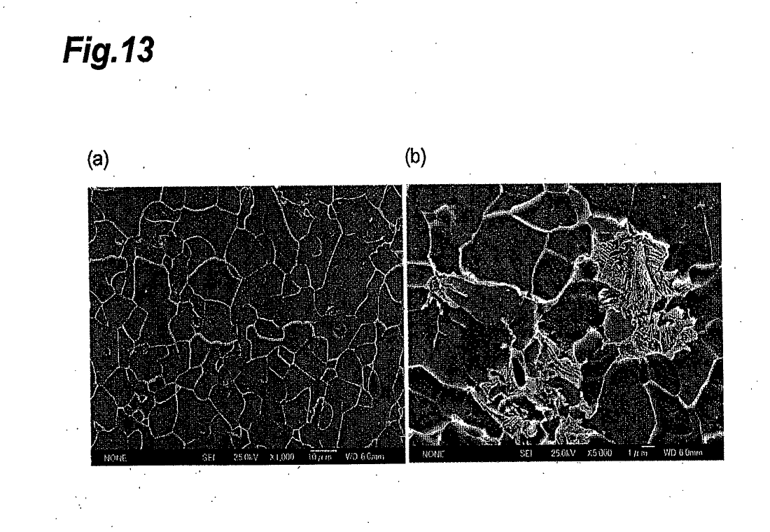

Each of (a) and (b) of FIG. 13 shows the metallic structure obtained by welding the S12C at a rotation speed of the rotary tool 5 of 800 rpm and a welding speed of the same of 400 mm/min. In this case, the maximum attained temperature of the welding part 3 exceeds 723° C. and 737° C., and the cooling rate of the same also exceeds 75° C./s. Therefore, it is found that the bainite phase is formed only partially, as shown in a magnification of the relevant section in (b) of FIG. 13. However, such partial formation has no adverse impact on the mechanical characteristics.

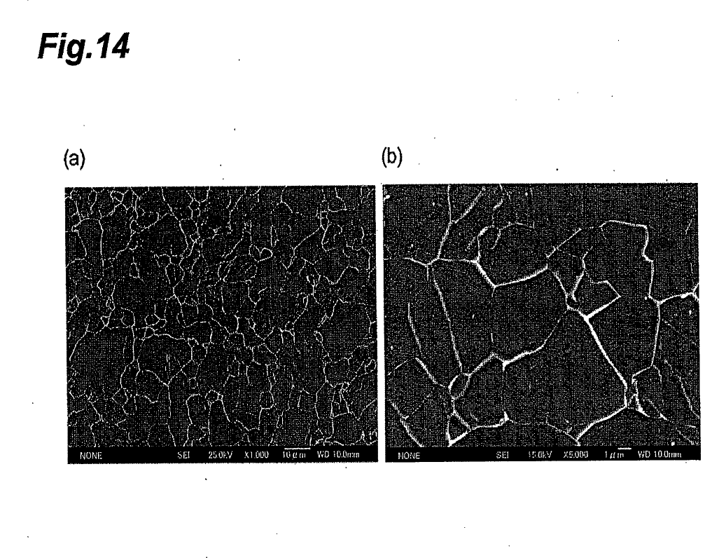

Each of (a) and (b) of FIG. 14 shows the metallic structure obtained by welding the S12C at a rotation speed of the rotary tool 5 of 400 rpm and a welding speed of the same of 50 mm/min. (b) of FIG. 14 is a magnification of (a) of FIG. 14. In this case, although the maximum attained temperature of the welding part 3 exceeds 723° C. and 737° C., the cooling rate is equal to or lower than 75° C./s. Therefore, the martensite phase or bainite phase is not formed in spite of the fact that the maximum attained temperature exceeds 723° C. and 737° C.

Each of (a) and (b) of FIG. 15 shows the metallic structure obtained by welding the S20C at a rotation speed of the rotary tool 5 of 200 rpm and a welding speed of the same of 400 mm/min. (b) of FIG. 15 is a magnification of (a) of FIG. 15. In this case, the martensite phase is not formed, as the maximum attained temperature of the welding part 3 becomes equal to or lower than 723° C. and 737° C.

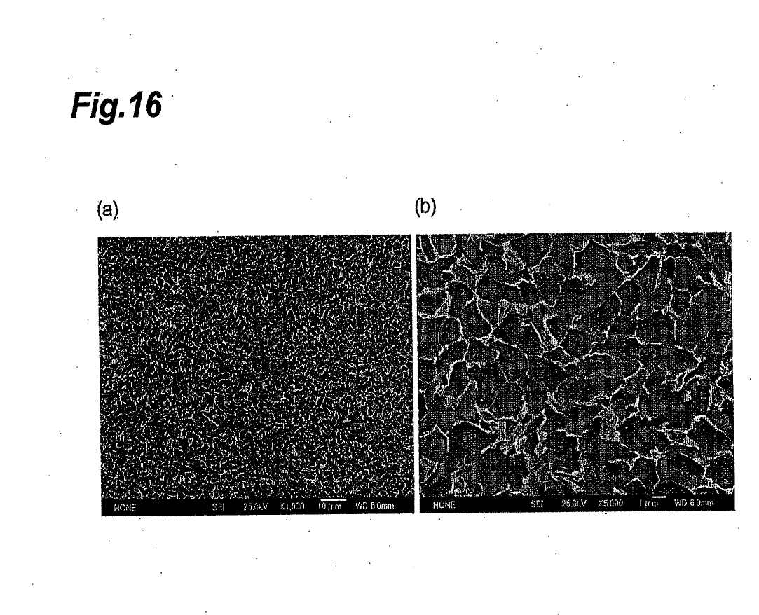

Each of (a) and (b) of FIG. 16 shows the metallic structure obtained by welding the S20C at a rotation speed of the rotary tool 5 of 400 rpm and a welding speed of the same of 400 mm/min. (b) of FIG. 16 is a magnification of (a) of FIG. 16. In this case, the martensite phase is not formed, as the maximum attained temperature of the welding part 3 becomes equal to or lower than 723° C. and 737° C.

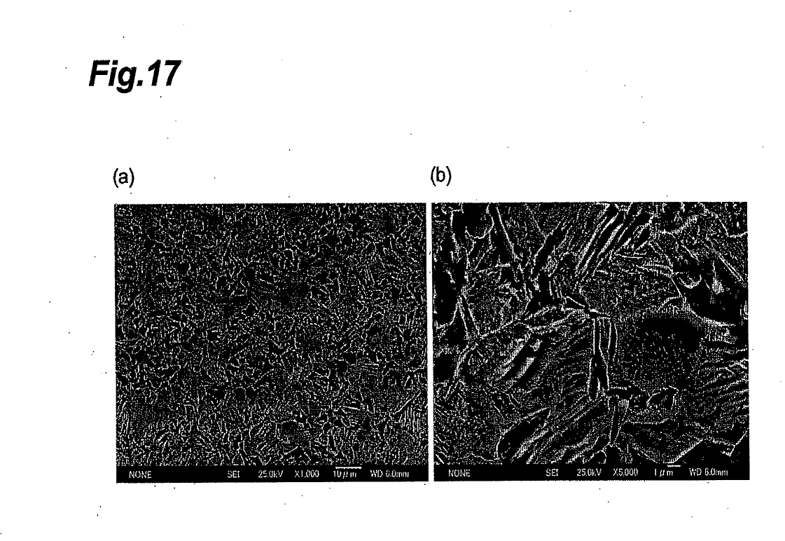

Each of (a) and (b) of FIG. 17 shows the metallic structure obtained by welding the S20C at a rotation speed of the rotary tool 5 of 600 rpm and a welding speed of the same of 400 mm/min. (b) of FIG. 17 is a magnification of (a) of FIG. 17. In this case, the maximum attained temperature of the welding part 3 exceeds 723° C. and reaches 737° C., and the cooling rate of the same also exceeds 75° C./s. Therefore, it is found that a black martensite phase is formed in the drawings.

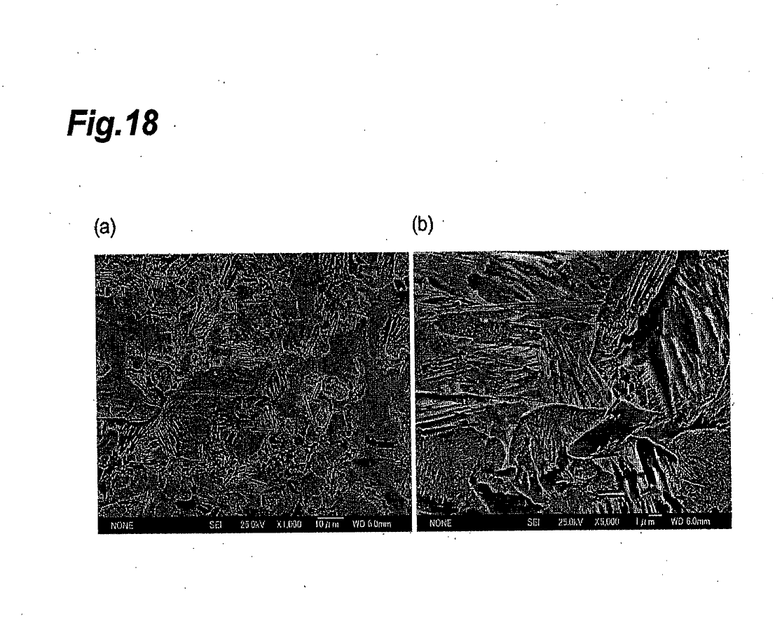

Each of (a) and (b) of FIG. 18 shows the metallic structure obtained by welding the S20C at a rotation speed of the rotary tool 5 of 800 rpm and a welding speed of the same of 400 mm/min. (b) of FIG. 18 is a magnification of (a) of FIG. 18. In this case, the maximum attained temperature of the welding part 3 exceeds 723° C. and 737° C., and the cooling rate of the same also exceeds 75° C./s. Therefore, it is found that a black martensite phase is formed in the drawings.

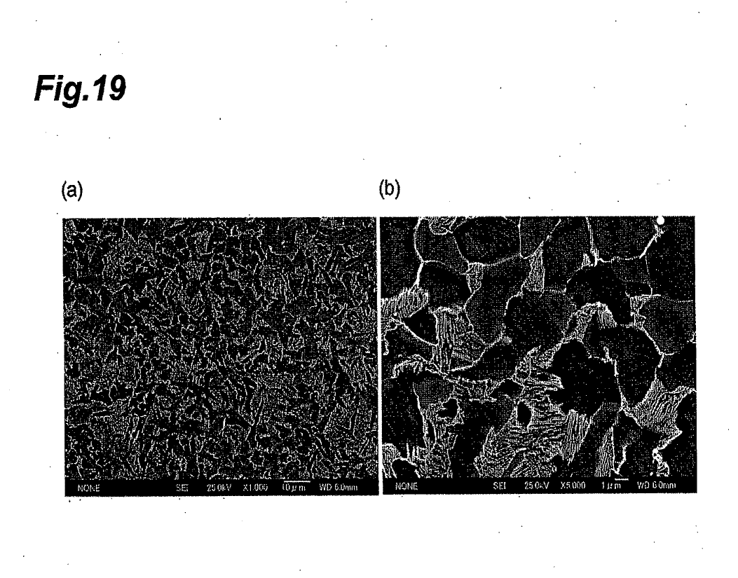

Each of (a) and (b) of FIG. 19 shows the metallic structure obtained by welding the S20C at a rotation speed of the rotary tool 5 of 400 rpm and a welding speed of the same of 50 mm/min. (b) of FIG. 19 is a magnification of (a) of FIG. 19. In this case, although the maximum attained temperature of the welding part 3 exceeds 723° C. and 737° C., the cooling rate is equal to or lower than 75° C./s. Therefore, the martensite phase is not formed in spite of the fact that the maximum attained temperature exceeds 723° C. and 737° C.

Each of (a) and (b) of FIG. 20 shows the metallic structure obtained by welding the S30C at a rotation speed of the rotary tool 5 of 200 rpm and a welding speed of the same of 400 mm/min. (b) of FIG. 20 is a magnification of (a) of FIG. 20. In this case, the martensite phase is not formed, as the maximum attained temperature of the welding part 3 is equal to or lower than 723° C. and 737° C.

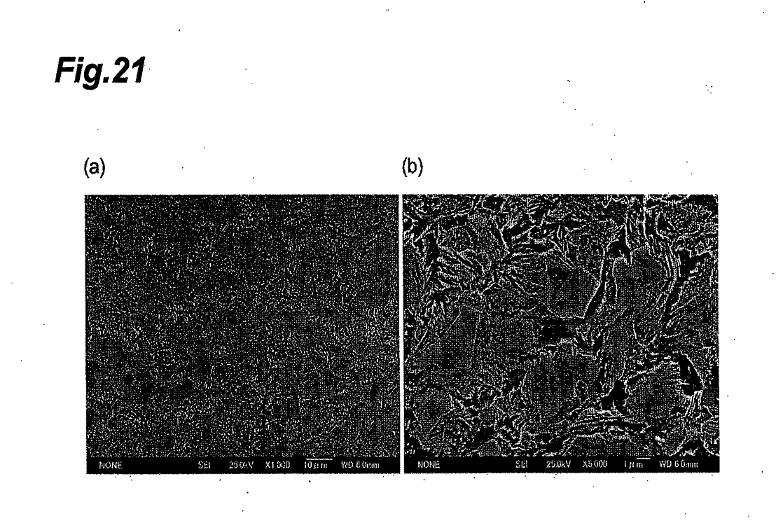

Each of (a) and (b) of FIG. 21 shows the metallic structure obtained by welding the S30C at a rotation speed of the rotary tool 5 of 400 rpm and a welding speed of the same of 400 mm/min. (b) of FIG. 21 is a magnification of (a) of FIG. 21. In this case, it is found that a black martensite phase is formed in the drawings, in spite of the fact that the maximum attained temperature of the welding part 3 of the S20C with the same conditions is equal to or lower than 723° C. and 737° C. It is considered that the martensite phase is formed because the temperature partially exceeds 723° C. or 737° C.

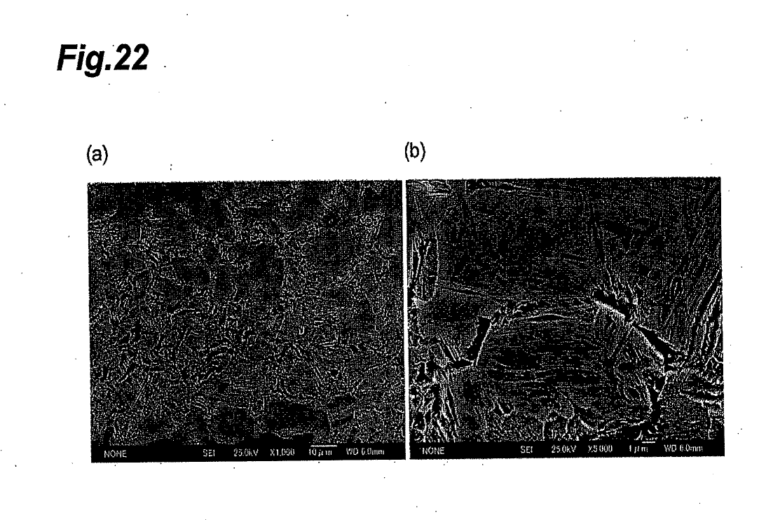

Each of (a) and (b) of FIG. 22 shows the metallic structure obtained by welding the S30C at a rotation speed of the rotary tool 5 of 600 rpm and a welding speed of the same of 400 mm/min. (b) of FIG. 22 is a magnification of (a) of FIG. 22. In this case, the maximum attained temperature of the welding part 3 exceeds 723° C. and reaches 737° C., and the cooling rate of the same also exceeds 75° C./s. Therefore, it is found that a black martensite phase is formed in the drawings.

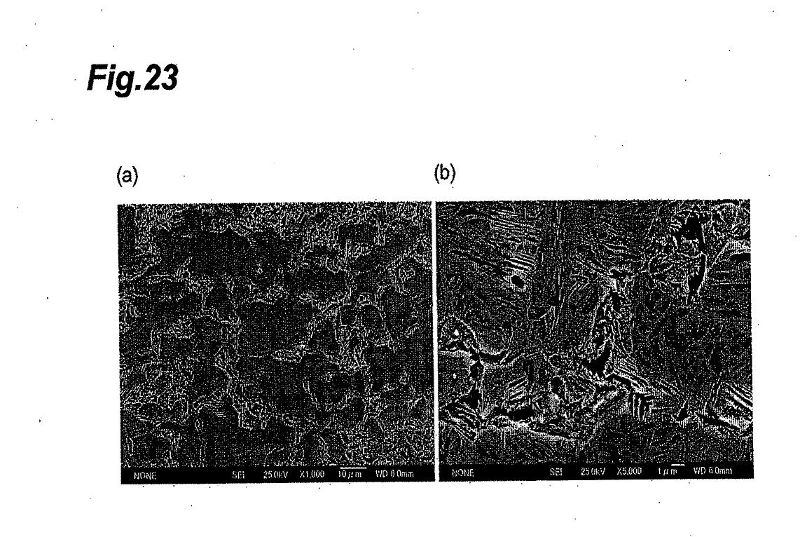

Each of (a) and (b) of FIG. 23 shows the metallic structure obtained by welding the S30C at a rotation speed of the rotary tool 5 of 800 rpm and a welding speed of the same of 400 mm/min. (b) of FIG. 23 is a magnification of (a) of FIG. 23. In this case, the maximum attained temperature of the welding part 3 exceeds 723° C. and 737° C., and the cooling rate of the same also exceeds 75° C./s. Therefore, it is found that a black martensite phase is formed in the drawings.

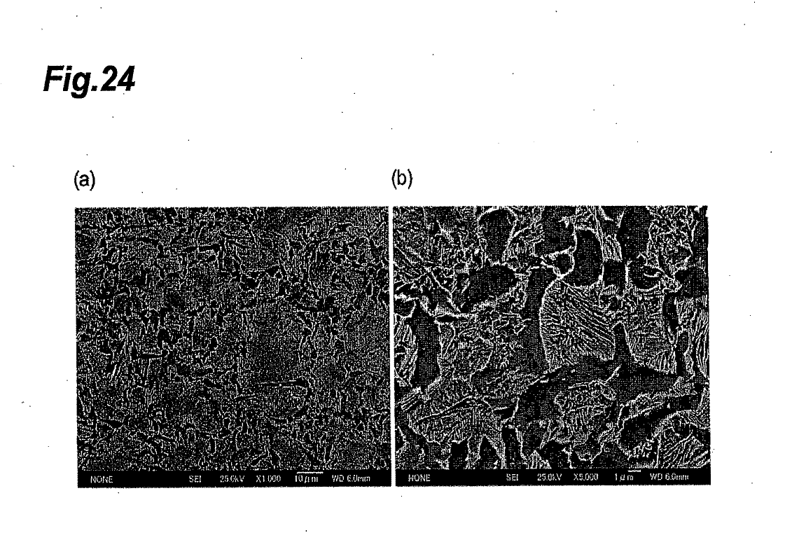

Each of (a) and (b) of FIG. 24 shows the metallic structure obtained by welding the S30C at a rotation speed of the rotary tool 5 of 400 rpm and a welding speed of the same of 50 mm/min. (b) of FIG. 24 is a magnification of (a) of FIG. 24. In this case, although the maximum attained temperature of the welding part 3 exceeds 723° C. and 737° C., the cooling rate is equal to or lower than 75° C./s. Therefore, the martensite phase is not formed in spite of the fact that the maximum attained temperature exceeds 723° C. and 737° C.

1. A method for welding a metallic material, the method comprising:
controlling a temperature of a welding part of a steel material having a carbon content of at least 0.15 mass % at 723° C. or lower;
inserting a rod-like rotary tool into the processing part; and
welding the steel material while rotating the rotary tool.

2. A method for welding a metallic material, the method comprising:
controlling a temperature of a welding part of a steel material having a carbon content of at least 0.15 mass % at 737° C. or lower;
inserting a rod-like rotary tool into the welding part; and
welding the steel material while rotating the rotary tool.

3. The method for welding a metallic material according to claim 1, wherein controlling the temperature of the welding part is performed by controlling a rotation speed and a movement speed of the rotary tool.

4. The method for welding a metallic material according to claim 1, wherein
the rotary tool is configured by a main body of the rod-like rotary tool and a probe that is disposed to pass through the inside of the main body of the rod-like rotary tool and inserted into the welding part, and
controlling the temperature of the welding part is performed by making the rotation speed of the main body of the rotary tool lower than a rotation speed of the probe.

5. A method for welding a metallic material, the method comprising:
inserting a rod-like rotary tool into a welding part of steel materials having a carbon content of at least 0.15 mass %;
rotating the rotary tool to weld two steel materials; and
controlling a cooling rate of the welding part obtained after the welding to 75° C./s or lower.

6. The method for welding a metallic material according to claim 5, wherein controlling the cooling rate of the welding part is performed by controlling a rotation speed and a movement speed of the rotary tool.

7. The method for welding a metallic material according to claim 5, wherein
the rotary tool is configured by a main body of the rod-like rotary tool and a probe that is disposed to pass through the inside of the main body of the rod-like rotary tool and inserted into the welding part, and
controlling the cooling rate of the welding part is performed by making the rotation speed of the main body of the rotary tool lower than a rotation speed of the probe.

8. The method for welding a metallic material according to claim 1, wherein the two steel materials are caused to abut against each other in the welding part, and the rotary tool is moved along a longitudinal direction of the welding part while rotating the rotary tool to weld the two steel materials together.

9. The method for welding a metallic material according to claim 1, wherein the two steel materials are superimposed on each other in the welding part, the rotary tool is inserted into the welding part, and the rotary tool is rotated to weld the two steel materials together.

10. The method for welding a metallic material according to claim 1, wherein the rotary tool is inserted into the welding part, and the rotary tool is rotated to modify surface sections of the steel materials in the welding part.

11. The method for welding a metallic material according to claim 1, wherein the rotary tool is configured by a WC.

12. The method for welding a metallic material according to claim 1, wherein the steel material is welded while supplying inactive gas to the welding part and the rotary tool.

13. A structure formed by welding two or more steel materials by means of the method for welding a metallic material according to claim 1.
